(19) United States
(12) Patent Application Publication
(10) Pub. No.: US 2026/0276509 A1
(43) Pub. Date: Sep. 17, 2026

(54) OPTICAL IMAGING SENSOR AND BIOLOGICAL REACTION SYSTEM

(71) Applicant: BIOACES (SHANGHAI) LIFE SCIENCE CO., LTD, Shanghai (CN)

(72) Inventor: Ziyin FENG, Shanghai (CN)

(21) Appl. No.: 19/526,849

(22) PCT Filed: Jul. 17, 2024
(86) PCT No.: PCT/CN2024/105911

§ 371 Date: Apr. 8, 2026

(30) Foreign Application Priority Data
Jul. 21, 2023 (CN) 202310903956.1

(51) Int. Cl. G01N 15/01; G01N 15/1434

(52) U.S. Cl. CPC G01N 15/01; G01N 15/1434; G01N 2015/144

(57) ABSTRACT

The present disclosure relates to an optical imaging sensor and a biological reaction system. The optical imaging sensor comprises: an illumination assembly, configured to generate an illumination beam in a first direction; a detection assembly, configured to receive and detect an imaging beam formed from the illumination beam and in a second direction, wherein the first direction and the second direction intersect with each other; and a housing, configured to accommodate the illumination assembly and the detection assembly, wherein the housing includes a window portion located on an emergent light path of the illumination assembly and on an incident light path of the detection assembly, so that the illumination beam and the imaging beam can transmit through the window portion.

### CROSS-REFERENCE TO RELATED APPLICATIONS

This application is based on and claims the benefit of priority to the Chinese patent application No. 202310903956.1 filed on Jul. 21, 2023, the disclosure of which is hereby incorporated by reference in its entirety into the present application.

### TECHNICAL FIELD

The present disclosure relates to the technical field of optical detection, and in particular, to an optical imaging sensor and a biological reaction system.

### BACKGROUND

In the research and production of biologically relevant field, it is often necessary to monitor a biological reaction process such as cell culture. However, a current monitoring approach is typically ex-situ and off-line, that is, a sample is drawn from a reaction vessel and the drawn sample is then analyzed. This monitoring approach is difficult to reflect a real state of the biological reaction in real time, and cannot provide a continuous control signal to help realize an automation control, and may also introduce contamination in the sampling process. Accordingly, there is a need for improving the monitoring of the biological reaction.

### SUMMARY

One objective of the present disclosure is to provide an optical imaging sensor and a biological reaction system.

According to a first aspect of the present disclosure, there is provided an optical imaging sensor including:
an illumination assembly, configured to generate an illumination beam in a first direction;
a detection assembly, configured to receive and detect an imaging beam formed from the illumination beam and in a second direction, wherein the first direction and the second direction intersect with each other; and
a housing, configured to accommodate the illumination assembly and the detection assembly, wherein the housing includes a window portion located on an emergent light path of the illumination assembly and on an incident light path of the detection assembly, so that the illumination beam and the imaging beam can transmit through the window portion.

In some embodiments, the illumination assembly includes:
an illumination source, configured to generate an initial beam.

In some embodiments, the illumination assembly further includes:
a beam shaping assembly, disposed on an emergent light path of the illumination source, and configured to perform beam shaping to generate the illumination beam with a preset shape.

In some embodiments, the beam shaping assembly includes:
a diaphragm, disposed on the emergent light path of the illumination source, and including a shading screen and a light-transmissive portion arranged in the shading screen, wherein the light-transmissive portion is rectangular; and
a cylindrical lens group, disposed on an emergent light path of the diaphragm;
wherein the cylindrical lens group and the diaphragm are configured to shape the beam to generate a substantially sheet-like illumination beam, and a plane in which the illumination beam is located is substantially perpendicular to the second direction.

In some embodiments, the cylindrical lens group includes a first cylindrical lens, wherein a convex surface of the first cylindrical lens is disposed facing the diaphragm.

In some embodiments, in a case that the illumination source is an incoherent light source, a minimum thickness Z of the illumination beam in the second direction satisfies Z=1.4*f*λ/(2*D), an effective length L of the illumination beam in the first direction satisfies L=2*n*π*Z²/λ, and an effective width of the illumination beam in a third direction satisfies W=D′*NA, wherein the third direction is perpendicular to both the first direction and the second direction, f is a focal length of the cylindrical lens group, λ is a wavelength of the illumination beam, D is a side length of the light-transmissive portion in the second direction, D′ is a side length of the light-transmissive portion in the third direction, n is a refractive index of a medium in which the illumination beam is transmitted, and NA is a numerical aperture of the illumination assembly.

In some embodiments, in a case that the illumination source is a coherent light a minimum thickness Z of the illumination beam in the second direction satisfies Z=2*λ/(π*NA), an effective length L of the illumination beam in the first direction satisfies L=2*n*λ/(π*NA²), and an effective width of the illumination beam in a third direction satisfies W=D′*NA, wherein the third direction is perpendicular to both the first direction and the second direction, λ is a wavelength of the illumination beam, NA is a numerical aperture of the illumination assembly, n is a refractive index of a medium in which the illumination beam is transmitted, and D′ is a side length of the light-transmissive portion in the third direction.

In some embodiments, the diaphragm includes an adjustable diaphragm, and a light-transmissive range of the light-transmissive portion of the adjustable diaphragm is changeable.

In some embodiments, the illumination assembly further includes:
a collimating lens group, disposed on an emergent light path of the beam shaping assembly and configured to perform beam collimation to generate the collimated illumination beam.

In some embodiments, the detection assembly includes:
an imaging lens group, configured to receive the imaging beam; and
an optical detector, disposed on an emergent light path of the imaging lens group and configured to sense the imaging beam.

In some embodiments, the imaging lens group includes:
an objective lens; and
a tube lens, disposed between the objective lens and the optical detector.

In some embodiments, the detection assembly further includes:
an optical filter, disposed on an incident light path of the optical detector, and configured to filter out a part of the imaging beam in a preset waveband, and enable a part of the imaging beam in another waveband to pass through.

In Some embodiments, the illumination assembly is positioned such that the illumination beam covers at least a focal plane of the detection assembly.

In some embodiments, the window portion is formed of a light-transmissive hard material or a light-transmissive flexible material.

In some embodiments, another portion of the housing than the window portion is formed of a non-light-transmissive material.

According to a second aspect of the present disclosure, there is provided a biological reaction system including:
a reaction vessel, at least a part of which is formed of a light-transmissive material; and
the optical imaging sensor as described above, wherein the window portion of the optical imaging sensor is configured to abut against the part of the reaction vessel formed of the light-transmissive material, to monitor a biological reaction in the reaction vessel.

In some embodiments, the biological reaction system further includes:
a memory, having instructions stored therein; and
a processor, communicatively connected with the optical imaging sensor and the memory, and when the instructions are executed by the processor, implementing image processing of an imaged image generated by the optical imaging sensor.
   Other features and their advantages of the present disclosure will become apparent from the following detailed description of exemplary embodiments of the present disclosure, which proceeds with reference to the accompanying drawings.

### BRIEF DESCRIPTION OF THE DRAWINGS

The accompanying drawings, which constitute a part of the specification, illustrate embodiments of the present disclosure and together with the description, serve to explain the principle of the present disclosure.

The present disclosure may be more clearly understood from the following detailed description taken in conjunction with the accompanying drawings, in which:

FIG. 1 shows a schematic structural diagram of a biological reaction system according to a specific embodiment of the present disclosure;

FIG. 2 shows a schematic diagram of the biological reaction system of FIG. 1 in the operating state;

FIG. 3 shows a partially enlarged schematic diagram of the biological reaction system of FIG. 1 in the operating state;

FIG. 4 shows a schematic structural diagram of a biological reaction system according to another specific embodiment of the present disclosure;

FIG. 5 shows a schematic structural diagram of an optical imaging sensor according to an exemplary embodiment of the present disclosure;

FIG. 6 shows a schematic structural diagram of a diaphragm according to a specific embodiment of the present disclosure;

FIG. 7 shows a schematic diagram of an illumination beam generated in a case that a cylindrical lens group including a first cylindrical lens is used, according to a specific embodiment of the present disclosure;

FIG. 8 shows a schematic cross-sectional view of the illumination beam of FIG. 7 in the x-z plane;

FIG. 9 shows a schematic cross-sectional view of the illumination beam of FIG. 7 in the x-y plane;

FIG. 10 shows an imaging view of cells in a biological reaction system according to a specific application example of the present disclosure;

FIG. 11 shows a graph of the total cell density in a biological reaction system over time, according to a specific application example of the present disclosure;

FIG. 12 shows a graph of viable cell density in a biological reaction system over time, according to a specific application example of the present disclosure;

FIG. 13 shows a graph of cell viability in a biological reaction system over time, according to a specific application example of the present disclosure;

FIG. 14 shows a graph of cell diameter in a biological reaction system over time, according to a specific application example of the present disclosure.

Note that in the embodiments described below, a same reference numeral is used in common between different drawings to denote a same portion or a portion having a same function, and a repetitive description thereof will be omitted. In this specification, like reference numerals and letters are used for designating like items, and therefore, once an item is defined in one drawing, further discussion thereof is not required in a subsequent drawing.

For convenience of understanding, a position, dimension, range, and the like of a respective structure shown in the drawings and the like do not necessarily indicate an actual position, dimension, range, and the like. Therefore, the disclosed invention is not limited to the position, dimension, range, and the like disclosed in the drawings and the like. Furthermore, the drawings are not necessarily drawn to scale, and some features may be

### DETAILED DESCRIPTION

Various exemplary embodiments of the present disclosure will now be described in detail with reference to the accompanying drawings. It should be noted that relative arrangement of parts and steps, numerical expressions and numerical values set forth in these embodiments do not limit the scope of the present disclosure unless specifically stated otherwise.

The following description of at least one exemplary embodiment is merely illustrative in nature and is in no way intended to limit the present disclosure, its application or usage. That is, the apparatus and method herein are shown by way of example, to illustrate different embodiments in the present disclosure, and not by way of limitation. Those skilled in the art will appreciate that they are merely illustrative of exemplary ways in which the invention may be practiced but not exhaustive.

Techniques, methods, and devices known to one of ordinary skill in the relevant art may not be discussed in detail but are intended to be part of the specification where appropriate.

In the research and production of biologically relevant field, monitoring of a reaction process such as biological culture is often involved. Currently, culture of, for example, cells or microorganisms may be accomplished by using a reaction vessel including a culture dish, a shake flask, a reactor, a disposable biological culture bag (e.g., a cell culture bag), and the like. In particular, the disposable biological culture bag is becoming increasingly popular for large scale culture in biopharming, synthetic biology, and the like.

The accuracy of the detection of parameters such as the number, viability and density of cells during the culture process will directly affect the optimization of culture condition, the control of production condition and the quality of the final biopharmaceutical product. Currently, an ex-situ and off-line detection mode is mainly used, that is, a sample is drawn from a reaction vessel (e.g., a reaction tank or a culture bag), and then the drawn sample is cell-analyzed. For example, a cell sensor based on dielectric spectrum or capacitance may be used for indirectly measuring partial parameters. In this measurement mode, an electrical signal generated by radio frequency electric field polarized cells can be collected in advance, and an association between the electrical signal and the parameter such as the viable cell density can be established. In the measuring process, an off-line detection device can be used for obtaining the measurement value of the electric signal, and the related parameter of the sample is obtained according to the pre-established association. However, the measurement mode based on the cell sensor described above can only roughly obtain the information on the number and density of the living cells, and has the low measurement accuracy, and cannot measure the parameter such as the total cell number (including the living cells and the dead cells) or the cell total density. In addition, the above indirect measurement scheme is also difficult to continuously monitor the cell growth state in real time, the process of drawing the sample may introduce the risk of cross contamination, and the process of preparing the sample and the time taken may also affect the accuracy and real-time performance of the monitoring result.

In order to solve the above problem, the present disclosure provides an optical imaging sensor and a biological reaction system, wherein the optical imaging sensor can perform the real-time optical imaging on microorganisms, animal or plant cells, or the like, in an original reaction environment, so as to achieve the continuous and real-time monitoring. Further, automatic processing of the imaged image may be realized in combination with, for example, an image processing software, to extract or calculate a required parameter therefrom, thereby analyzing, in real time, the microorganisms, the animal or plant cells, or the like, in the original reaction environment. The optical imaging sensor of the present disclosure may be used in a variety of reaction vessels such as the cell culture dish, the T-flask, the cell culture bag, and the like, and may be used for obtaining continuous, real-time state data of the cells in the original culture environment, such as the cell density, the cell viability, the cell diameter/volume, the cell classification grouping, the cell performance (e.g., the cytokine secretion), the cell characteristic (e.g., the surface marker or the genetic material), the cell growth rate, and the cell distribution at different levels in the reaction vessel.

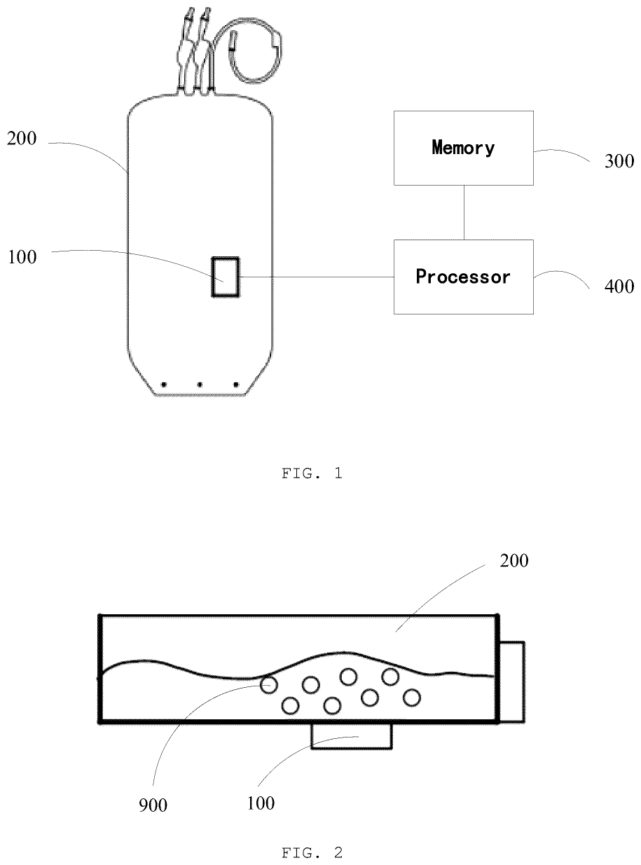

In an exemplary embodiment of the present disclosure, the optical imaging sensor for imaging a sample under test may be provided separately or may be integrated with, for example, the reaction vessel for culturing cells, to form at least a part of the biological reaction system. As shown in FIGS. 1 to 4, in some embodiments of the present disclosure, the biological reaction system may include the reaction vessel 200 and the optical imaging sensor 100. The reaction vessel 200 may further be provided therein with a stirring portion 210 and the like, to stir the liquid containing the biological particles 900 therein during the reaction process, so as to achieve a better reaction effect. At least a portion of the reaction vessel 200 may be formed of a light-transmissive material, so that a window portion 131 of the optical imaging sensor 100 can abut against a light-transmissive portion of the reaction vessel 200, thereby allowing an illumination beam generated by the optical imaging sensor 100 to irradiate the sample in the reaction vessel 200, and an imaging beam generated by the interaction of the illumination beam with the biological particles 900 in the sample can return through the reaction vessel 200 to the optical imaging sensor 100, for imaging. In a specific example, the entire reaction vessel 200 may be formed of the light-transmissive material such that the window portion 131 of the optical imaging sensor 100 can abut against most locations on the reaction vessel 200, to monitor the biological reaction at the desired location. In some other specific examples, only a portion of the reaction vessel 200 is formed of the light-transmissive material, and another portion may be formed of a non-light-transmissive material, so as to reduce unnecessary ambient light from entering the reaction vessel 200 as much as possible to reduce the interference to the biological reaction therein, while ensuring the monitoring effect of the optical imaging sensor 100. For example, the light-transmissive portion of the reaction vessel 200 may be an elongated portion extending along its longitudinal axis, such that the window portion 131 of the optical imaging sensor 100 may be moved along the longitudinal axis of the reaction vessel 200, to enable monitoring of the biological reactions at multiple levels in the reaction vessel 200.

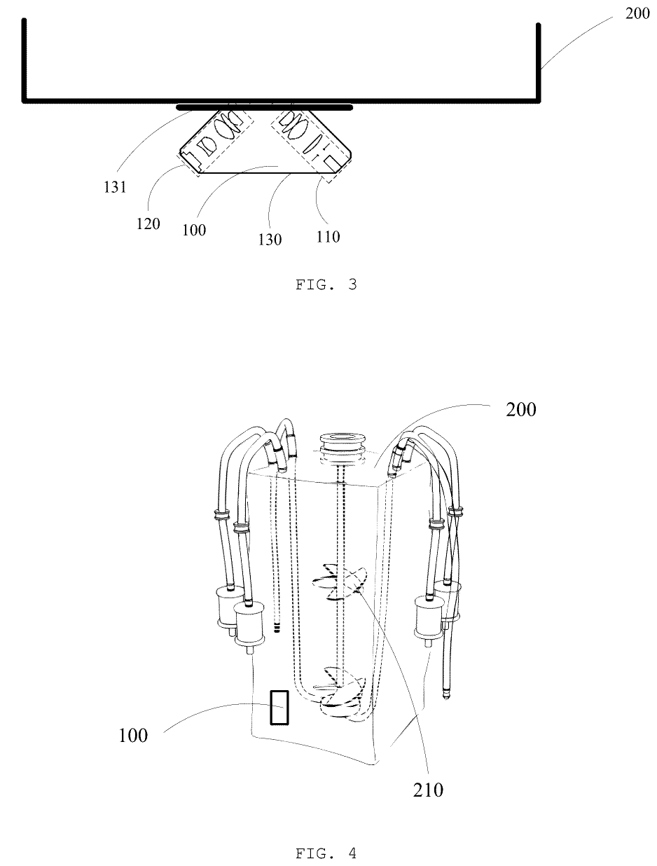

In a specific example shown in FIGS. 1 to 3, in a case that the biological reaction system is in the operating state, the reaction vessel 200 may be placed horizontally, the optical imaging sensor 100 may be disposed at the bottom of the reaction vessel 200, and the window portion 131 of the optical imaging sensor 100 may abut against the light-transmissive portion of the reaction vessel 200. In a specific example shown in FIG. 4, in a case that the biological reaction system is in the operating state, the reaction vessel 200 may be placed vertically, the optical imaging sensor 100 may be disposed at the side portion of the reaction vessel 200, for example, attached to the sidewall of the reaction vessel 200, and the window portion 131 of the optical imaging sensor 100 may abut against the light-transmissive portion of the reaction vessel 200.

In some embodiments, as shown in FIG. 1, the biological reaction system may further include a memory 300 and a processor 400. For example, the memory 300 and the processor 400 may be part of a computer device communicatively connected with the optical imaging sensor 100. In some embodiments, the computer device may be provided separately, and in some other embodiments, the computer device may alternatively be a part of the biological reaction system. The memory 300 may have instructions stored therein. The processor 400 may be communicatively connected with the optical imaging sensor 100 and the memory 300, and when the instructions are executed by the processor 400, may implement image processing of the imaged image generated by the optical imaging sensor 100, such as cell counting, viability analysis, and the like, from the imaged image. In some embodiments, the memory 300 may also be used for storing raw image data from the optical imaging sensor 100, various intermediate data involved in the image processing, and result data of the image processing. Furthermore, in some embodiments, the memory 300 may also be directly communicatively connected with the optical imaging sensor 100, which is not limited herein.

The memory 300 may be either a volatile memory or a nonvolatile memory, or may include both the volatile memory and the nonvolatile memory. The non-volatile memory may be a Read-Only Memory (ROM), a Programmable Read-Only Memory (PROM), an Erasable Programmable Read-Only Memory (EPROM), an Electrically Erasable Programmable Read-Only Memory (EEPROM), or a flash memory. The volatile memory can be a Random Access Memory (RAM), which is used as an external cache. By way of example but not limitation, many forms of RAM are available, such as a Static Random Access Memory (SRAM), a Dynamic Random Access Memory (DRAM), a Synchronous Dynamic Random Access Memory (SDRAM), a Double Data Rate Synchronous Dynamic Random Access Memory (DDRSDRAM), an Enhanced Synchronous Dynamic Random Access Memory (ESDRAM), a Synchronous Link Dynamic Random Access Memory (SLDRAM), and a Direct Memory Bus Random Access Memory (DR RAM). It should be noted that the memory 300 described herein is intended to include, without being limited to, these and any other suitable types of memory.

The processor 400 may be an integrated circuit chip with a signal processing capability. The above processor may be a general purpose processor, a Digital Signal Processor (DSP), an Application Specific Integrated Circuit (ASIC), a Field Programmable Gate Array (FPGA) or another programmable logic device, a discrete gate or transistor logic device, a discrete hardware component. Various methods, steps, and logic blocks referred to in the embodiments of the present disclosure may be implemented or performed. The general purpose processor may be a microprocessor or the processor may be any conventional processor or the like, which may be an X86 architecture or an ARM architecture or the like.

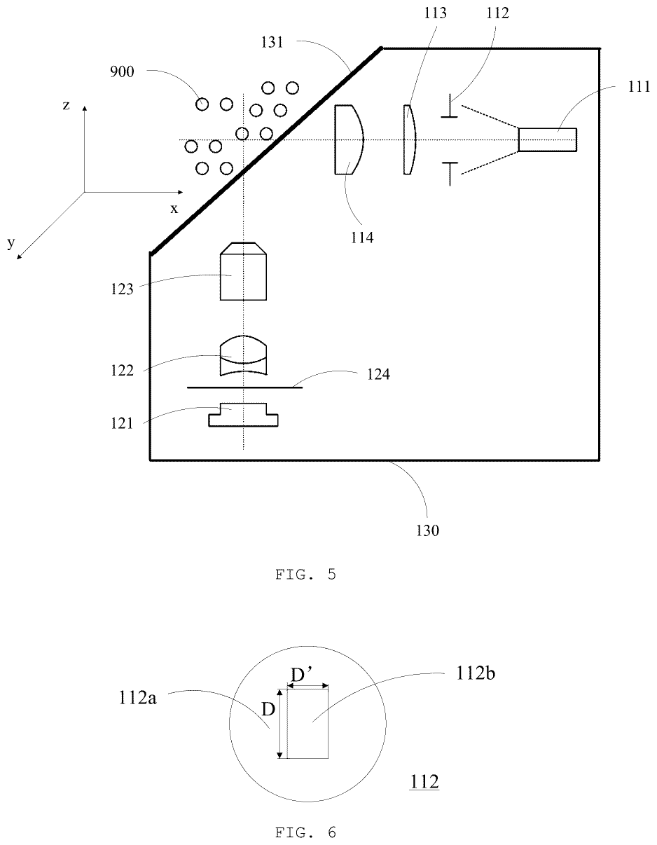

In an exemplary embodiment of the present disclosure, as shown in FIGS. 3 and 5, the optical imaging sensor 100 may include an illumination assembly 110, a detection assembly 120, and a housing 130. The illumination assembly 110 may be configured to generate the illumination beam in a first direction (i.e., a direction in which the x-axis is located in FIG. 5); the detection assembly 120 may be configured to receive and detect the imaging beam formed from the illumination beam and in a second direction (i.e., a direction in which the z-axis is located in FIG. 5), here the first direction and the second direction may intersect with or be perpendicular to each other. The housing 130 may be configured to accommodate the illumination assembly 110 and the detection assembly 120, and the housing 130 may include the window portion 131 which may be located on the emergent light path of the illumination assembly 110 and on the incident light path of the detection assembly 120, such that the illumination beam and the imaging beam can transmit through the window portion 131.

In some embodiments, as shown in FIG. 5, the illumination assembly 110 may include an illumination source 111 which may be configured to generate an initial beam. The initial beam may be an incoherent beam or a coherent beam, and accordingly, the illumination beam irradiated onto the sample under test may be the incoherent beam or the coherent beam. In a specific example, elastic scattering may occur between the illumination beam and the biological particles 900 in the sample under test, and the sample under test may be observed in terms of morphology or the like based on the scattered light generated. In this case, the illumination beam may be the incoherent beam, and accordingly, the illumination source 111 may be an incoherent light source such as a light emitting diode (LED), which may generate, for example, white light for convenient viewing. Moreover, especially in a case that the illumination source 111 is the incoherent light source, it may generally have a smaller volume, and accordingly, the entire optical imaging sensor 100 may also have a smaller volume. For example, in a case that the incoherent light source is provided, a characteristic dimension (e.g., the length, width, or thickness) of the housing of the optical imaging sensor 100 can be less than 10 cm. In another specific example, the illumination beam may be used for exciting a fluorescence signal of the biological particles 900 in the sample under test, so as to realize the fluorescence detection for the sample under test based on the generated fluorescence signal, to acquire the information related to the biological particles 900. In this case, in order to improve the excitation effect, the illumination beam may be the coherent beam in a desired waveband, and accordingly, the illumination source 111 may include a coherent light source such as a laser, or may include an optical fiber or the like for transmitting the coherent beam. It may be appreciated that in some embodiments, the illumination source 111 may alternatively be a hybrid light source that may generate both the incoherent beam and the coherent beam, or may include a plurality of illumination sources 111, to switch to the respective illumination beam as desired.

In some embodiments, the illumination assembly 110 may further include a beam shaping assembly, which may be disposed on the emergent light path of the illumination source 111, and the beam shaping assembly may be configured to perform beam shaping to generate the illumination beam with a preset shape, so as to achieve a better monitoring effect. In a specific example, as shown in FIG. 5, the beam shaping assembly may include a diaphragm 112 and a cylindrical lens group 113, the diaphragm 112 and the cylindrical lens group 113 may be configured to shape the beam to generate the substantially sheet-shaped illumination beam, and a plane in which the illumination beam is located may be perpendicular or substantially perpendicular to the second direction.

In a specific example shown in FIG. 5, the diaphragm 112 may be disposed on the emergent light path of the illumination source 111. As shown in FIG. 6, the diaphragm 112 may include a shading screen 112a and a light-transmissive portion 112b arranged in the shading screen 112a, wherein the 44 the light-transmissive portion 112b may affect the shape of the cross-section of the illumination beam in the y-z plane (wherein the y-direction is perpendicular to both the x-direction and the z-direction) shown in FIG. 5. In some embodiments, the light-transmissive portion 112b may be rectangular. In a specific example, the light-transmissive portion 112b may be square. In order to have substantially uniform illumination in the observation field of view of the detection assembly 120, for better observing the sample under test and for more conveniently calculating the required parameter, an effective width of the illumination beam (a width of a part of the beam having an intensity above a threshold, to provide sufficient illumination resolution) may be greater than a width of the field of view of the detection assembly 120 (or the objective lens 123 in the detection assembly 120 as described below), so that the illumination beam may be distributed across the entire field of f view. Further, in some embodiments, the diaphragm 112 may include an adjustable diaphragm, a light-transmissive range of the light-transmissive portion of the adjustable diaphragm is changeable, to change the shape of the illumination beam as needed, for example, to change the effective width of the illumination beam so as to achieve the desired illumination range.

In a specific example shown in FIG. 5, the cylindrical lens group 113 may be disposed on the emergent light path of the diaphragm 112. As mentioned above, the cylindrical lens group 113 may, together with the diaphragm 112, shape the initial beam into the sheet-like illumination beam, the normal direction of the illumination beam is substantially along the second direction, and the plane of the illumination beam extends in the x-y plane. It is noted that the sheet-like beam herein means that the thickness of the beam in the z-direction is much less (e.g., more than 10 times less) than its effective length in the x-direction (a length of the part of the beam having the intensity above the threshold, to provide sufficient illumination resolution), and the thickness of the beam is much less than its effective width in the y-direction.

The cylindrical lens group 113 may have various settings to produce the desired sheet-like beam. Furthermore, one or more cylindrical lenses employed in the cylindrical lens group 113 may each be a single-piece cylindrical lens, or may be a multiple-piece apochromatic cylindrical lens, to make the effectively illuminated portion of the sheet-like beam more uniform and avoid the effect of chromatic aberration on the optical observation.

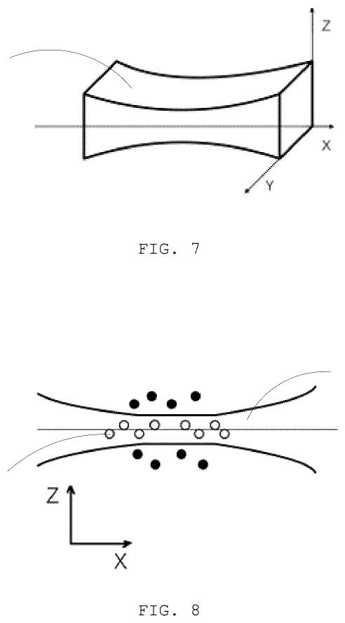

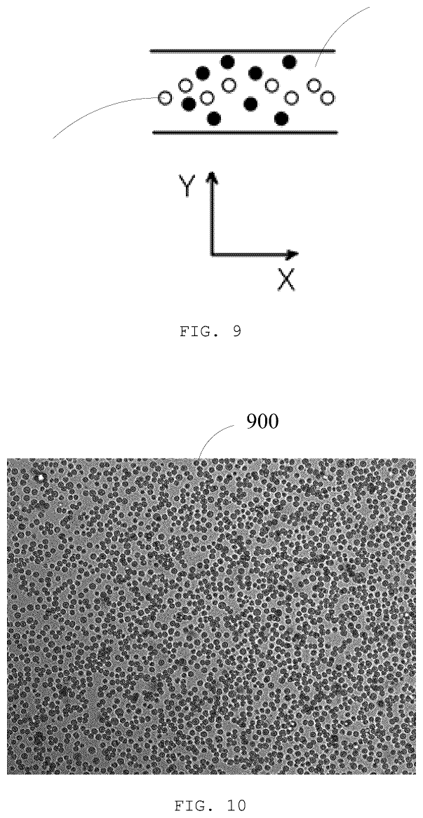

In a specific example, as shown in FIG. 5, the cylindrical lens group 113 may include a first cylindrical lens, wherein a convex surface of the first cylindrical lens may be disposed facing the diaphragm 112. In this case, the first cylindrical lens may generate a sheet-like beam as shown in FIGS. 7 to 9, and the edge of the sheet-like beam extending in the x-direction may have some curvature.

It may be appreciated that the geometry of the generated illumination beam is related to a corresponding component in the illumination assembly 110 and a parameter of the medium in which the illumination beam is transmitted. In some embodiments, the thickness and the length of the illumination beam may be calculated from diffraction limit. For example, in the case that the illumination source 111 is the incoherent light source, a minimum thickness Z of the illumination beam 119 in the second direction satisfies Z=1.4*f *λ/(2*D), the effective length L of the illumination beam 119 in the first direction satisfies L=2*n *π* Z²/λ, and the effective width of the illumination beam 119 in a third direction (i.e., a direction in which the y-axis is located in FIG. 5) satisfies W=D′*NA, wherein the third direction may be perpendicular to both the first direction and the second direction, f is a focal length of the cylindrical lens group 113, λ is a wavelength of the illumination beam 119, D is a side length of the light-transmissive portion 112b in the second direction (i.e., the direction in which the z-axis is located in FIG. 5), D′ is a side length of the light-transmissive portion 112b in the third direction (i.e., the direction in which the y-axis is located in FIG. 5), n is a refractive index of the medium in which the illumination beam 119 is transmitted (in this disclosure, the illumination beam may be transmitted primarily in vacuum or air, so the refractive index n may be 1), and NA is a numerical aperture of the illumination assembly 110 (or a collimating lens group 114 as described below). In a specific example, a position where the thickness of the illumination beam 119 is √2Z may be determined as two endpoints corresponding to the effective length of the illumination beam.

In some other embodiments, in the case that the illumination source 111 is the coherent light source, the minimum thickness Z of the illumination beam 119 in the second direction satisfies Z=2*λ/(π*NA), the effective length L of the illumination beam 119 in the first direction satisfies L=2*n*λ/(π*NA²), and the effective width of the illumination beam 119 in the third direction satisfies W=D′*NA, wherein λ is the wavelength of the illumination beam 119, NA is the numerical aperture of the illumination assembly 110 (or the collimating lens group 114 as described below), n is the refractive index of the medium in which the illumination beam 119 is transmitted (in this disclosure, the illumination beam may be transmitted primarily in vacuum or air, so the refractive index n may be 1), and D′ is the side length of the light-transmissive portion 112 in the third direction (i.e., the direction in which the y-axis is located in FIG. 5). Likewise, the position where the thickness of the illumination beam 119 is √2Z may be determined as two endpoints corresponding to the effective length of the illumination beam.

In some embodiments, to further reduce the thickness of the illumination beam 119, such that the optical imaging sensor 100 can have a finer axial resolution in the thickness direction during the layer-by-layer analysis of the sample under test (the axial resolution being related to the thickness of the illumination beam and the numerical aperture of the objective lens 123 in the detection assembly 120), or to make the energy of the coherent beam more concentrated to better excite the fluorescence signal in the sample under test, as shown in FIG. 5, the illumination assembly 110 may further include a collimating lens group 114, the collimating lens group 114 may be disposed on the emergent light path of the beam shaping assembly, and may be configured to perform beam collimation to generate the collimated illumination beam, e.g., to make the thickness of the illumination beam in the second direction thinner than that without the collimating lens group 114. In some embodiments, the collimating lens group 114 may include one or more lenses.

Further, as shown in FIG. 5, the detection assembly 120 may include an imaging lens group and an optical detector 121. The imaging lens group may be configured to receive the imaging beam, which may be from a layer of the sample under test illuminated by the illumination beam. In some embodiments, the imaging lens group may include an objective lens 123 and a tube lens 122 disposed between the objective lens 123 and the optical detector 121. It may be appreciated that, in some other embodiments, the imaging lens group for collecting the imaging beam may be disposed in another manner, which is not limited herein.

The optical detector 121 may be disposed on the emergent light path of the imaging lens group, and may be configured to sense the imaging beam, thereby forming a two-dimensional image (including an elastically scattered light image and/or fluorescence signal image) of the sample under test. In a specific example, the optical detector 121 may include a charge coupled device (CCD) sensor or a complementary metal Oxide semiconductor (CMOS) sensor. In addition, by scanning the sample under test with the optical sheet in the second direction or by moving the entire optical imaging sensor 100 in the second direction, layer-by-layer imaging of the sample under test can be achieved, so that tomographic images of the sample under test at different depths are acquired, and further, reconstruction of three-dimensional information of the sample under test is achieved.

In some embodiments, especially in the case of fluorescence imaging, as shown in FIG. 5, the detection assembly 120 may further include an optical filter 124, the optical filter 124 may be disposed on the incident light path of the optical detector 121, and may be configured to filter out a part of the imaging beam in a preset waveband and enable a part of the imaging beam in another waveband to pass through (for example, filtering out a part of the imaging beam in the waveband of the illumination beam, to enable the fluorescence signal pass through). In this way, the interference of light outside the waveband of the fluorescence signal to the detection can be reduced, to help better detect the sample under test.

In some embodiments, to achieve a better imaging effect, as shown in FIG. 5, the illumination assembly 110 may be positioned such that the illumination beam covers at least a focal plane of the detection assembly 120, such that the detection assembly 120 only senses the image of the biological particles located near the focal plane of the imaging lens group. Alternatively, the illumination assembly 110 and the detection assembly 120 are positioned such that the area illuminated by the sheet-like illumination beam is substantially located in the focal plane of the detection assembly 120, thereby forming the best imaging effect.

In some embodiments, as shown in FIGS. 3 and 5, both the illumination assembly 110 and the imaging 120 are accommodated in the housing 130 of the optical imaging sensor 100, thereby forming a portable whole. When it is required to monitor the biological reaction such as the cell culture in the reaction vessel 200 such as the reaction bag, the optical imaging sensor 100 may abut against the light-transmissive portion of the reaction vessel 200, wherein the window portion 131 of the housing 130 is opposed to the light-transmissive portion of the reaction vessel 200, so that the illumination beam and the imaging beam may be transmitted in the desired light path. In some embodiments, the window portion 131 may be formed of a light-transmissive hard material (e.g., quartz). In this way, especially in a case of monitoring the biological reaction in the reaction vessel 200 formed of a flexible material, the hard window portion 131 is advantageous in making the region of the reaction vessel 200 abutting against the optical imaging sensor 100 flatter, thereby improving the observation effect. In some other embodiments, the window portion 131 may alternatively be formed of a light-transmissive flexible material, such as Polyethylene (PE). In this way, the window portion 131 can conform against the surface of the reaction vessel 200 of various shapes to improve the monitoring effect. Furthermore, in some embodiments, another portion of the housing 130 than the window portion 131 may be formed of the non-light-transmissive material, to avoid undesired interference from ambient light entering the optical imaging sensor 100. In a specific example, the housing 130 may be formed by connecting several independent components, or the housing 130 may be integrally formed, which is not limited herein.

Some specific application examples in the optical imaging sensor and the biological reaction system are listed below.

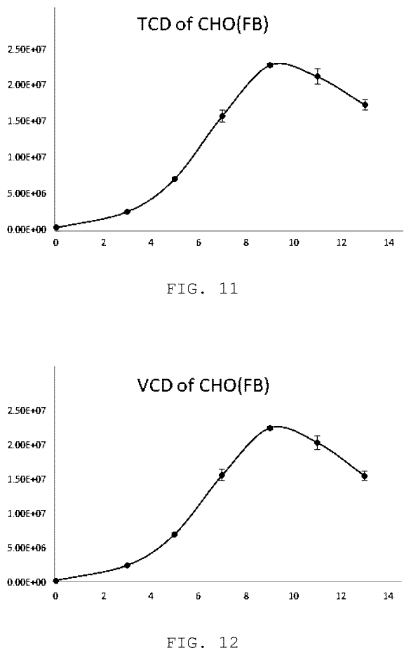

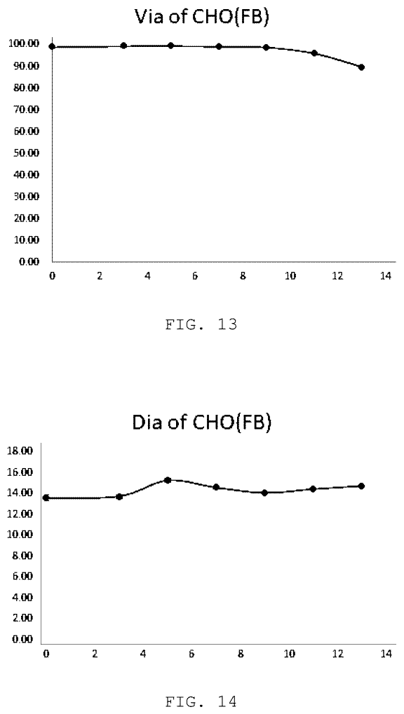

In a-specific application example, the optical imaging sensor may be used for monitoring a range of parameters of CHO cells in the biological reaction system. Under a fed-batch process (FB) condition, the growth process of the CHO cells in the reaction vessel may include a logarithmic growth phase, a volume increase phase and a plateau phase, wherein the volume increase phase is between the logarithmic growth phase and the plateau phase. During the volume growth phase, the cells do not stop growing, but instead grow in a manner that changes from an increase in cell number to an increase in single cell biomass, at which point the cell volume and diameter will increase. For example, during the volume increase phase, the cell diameter may be increased from 17 μm to 23 μm, while the monoclonal antibody titer distribution in the cell volume increase process may be significantly higher than that in the cell volume non-increase process. The optical imaging sensor proposed in this disclosure can be used for monitoring the CHO cells in real time throughout the culture process. For example, FIG. 10 shows an optical imaging photo of the cells 900 taken during culture. Based on the optical imaging photo shown in FIG. 10, the information such as a change in Total Cell Density (TCD) over time (see FIG. 11, wherein the horizontal axis represents the number of days and the vertical axis represents TCD), a change in Viable Cell Density (VCD) over time (see FIG. 12, wherein the horizontal axis represents the number of days and the vertical axis represents VCD), a change in cell viability (Via) over time (see FIG. 13, wherein the horizontal axis represents the number of days and the vertical axis represents Via), and a change in diameter (Dia) over time (see FIG. 14, wherein the horizontal axis represents the number of days and the vertical axis represents Dia) of the CHO cells can be extracted or calculated using a relevant image processing software, and the cell growth curves and the like can be further plotted, providing timely and effective help for scientific research workers in optimizing and changing processes in antibody production.

Specifically, in the process of calculating the cell density, a field area of the objective lens 123 in the detection assembly 120 may be taken as the area, and in a case that the depth of field of the objective lens 123 is larger than the thickness Z of the illumination beam, an effective volume may be obtained by multiplying the thickness Z of the illumination beam by the above field area, and the cell density may be calculated based on the effective volume. Alternatively, in a case that the depth of field of the objective lens 123 is smaller than the thickness Z of the illumination beam, the effective volume may be obtained by multiplying the depth of field of the objective lens 123 by the above field area, and then the cell density in the sample under test may be calculated based on the effective volume.

In the optical imaging sensor and the biological reaction system of the present disclosure, the illumination optical path and the detection optical path which intersect with or even are orthogonal to each other may be adopted, and the sheet-like illumination beam is irradiated from the side of the sample under test, so that only the sample in the focal plane area (within the depth of field) of the detection assembly is imaged, and by detecting the imaging in the orthogonal direction, the influence of the out-of-focus background on the imaging quality can be effectively avoided, and simultaneously, high imaging contrast and natural realization of optical tomography can be achieved to construct a three-dimensional model, which greatly reduces the photobleaching and phototoxicity of the illumination beam on the sample under test, so that it is suitable for imaging the living biological samples for a long time of hours or even days, without operations such as modeling in advance. For example, with the optical imaging sensor of the present disclosure, during the entire course of the biological reaction within the reaction vessel, detection and statistics of the parameter such as the count, the density, the viability, the volume, the grouping classification, and the growth rate of the biological sample can be achieved. In addition, the optical imaging sensor of the present disclosure can be integrated in the housing, has a small volume, low cost and is convenient to carry; when the measurement is needed, the optical detection can be immediately realized as long as the window portion of the optical imaging sensor abuts against the light-transmissive portion of the reaction vessel, and the measurement process is non-invasive and non-destructive, does not require sampling or sample pre-treatment, and thus does not cause contamination to the reactant in the reaction vessel or interfere with the reaction process (e.g., cell culture, metabolism, and the like). Moreover, since there is no need to perform pre-staining treatment on the biological particles (for example, using the trypan blue staining method to monitor the cell activity, or using the specific fluorescent reagent to monitor the cell characteristic r the surface marker), the pretreatment time is saved, and the influence of chemical toxicity of the reagent on the cell state and characteristic expression is avoided, thereby facilitating the realization of in-situ, real-time, direct and continuous dynamic cell analysis.

In all examples shown and discussed herein, any particular value should be construed as exemplary only and not as limiting. Thus, other examples of the exemplary embodiments may have different values.

The terms “front,” “back,” “top,” “bottom,” “above,” “under,” and the like in the description and in the claims, if any, are used for descriptive purposes and not necessarily for describing permanent relative positions. It is to be understood that the terms so used are interchangeable under appropriate circumstances, such that the embodiments of the present disclosure described herein are, for example, capable of operation in other orientations than those illustrated or otherwise described herein.

As used herein, the word “exemplary” means “as an example, instance, or illustration,” and not as a “model” that is to be reproduced exactly. Any implementation exemplarily described herein is not necessarily to be construed as preferred or advantageous over other implementations. Furthermore, there is no intention to be bound by any expressed or implied theory presented in the preceding TECHNICAL FIELD, BACKGROUND, SUMMARY OR DETAILED DESCRIPTION.

As used herein, the term “substantially” is intended to encompass any minor variations due to design or manufacturing imperfections, tolerances of devices or components, environmental influences and/or other factors. The word “substantially” also allows for differences from a perfect or ideal situation due to parasitic effect, noise, and other practical considerations that may exist in a practical implementation.

The above description may indicate elements or nodes or features being “connected” or “coupled” together. As used herein, unless expressly stated otherwise, “connected” means that one element/node/feature is directly connected to (or directly communicates with) another element/node/feature, either electrically, mechanically, logically, or otherwise. Similarly, unless expressly stated otherwise, “coupled” means one element/node/feature may be mechanically, electrically, logically or otherwise joined to another element/node/feature in a direct or indirect manner to allow interaction, even though the two features may not be directly connected. That is, “coupled” is intended to include both direct and indirect joining of elements or other features, including connections utilizing one or more intermediate elements.

It will be further understood that the term “include/comprise”, when used herein, specifies the presence of stated features, integers, steps, operations, elements, and/or components, but do not preclude the presence or addition of one or more other features, integers, steps, operations, elements, components, and/or combinations thereof.

Those skilled in the art will appreciate that the boundaries between the above described operations merely illustrative. Multiple operations may be combined into a single operation, single operations may be distributed in additional operations, and operations may be performed at least partially overlapping in time. Moreover, alternative embodiments may include multiple instances of a particular operation, and the order of operations may be altered in various other embodiments. However, other modifications, variations, and alternatives are also possible. The specification and drawings are, accordingly, to be regarded in an illustrative rather than a restrictive sense. Although some specific embodiments of the present disclosure have been described in detail by way of example, it should be understood by those skilled in the art that the above examples are for illustration only and are not intended to limit the scope of the present disclosure. The various embodiments disclosed herein may be combined in any combination without departing from the spirit and scope of the present disclosure. Those skilled in the art will also appreciate that various modifications might be made to the embodiments without departing from the scope and spirit of the present disclosure. The scope of the present disclosure is defined by the appended claims.

1. An optical imaging sensor, comprising:
an illumination assembly, configured to generate an illumination beam in a first direction;
a detection assembly, configured to receive and detect an imaging beam formed from the illumination beam and in a second direction, wherein the first direction and the second direction intersect with each other; and
a housing, configured to accommodate the illumination assembly and the detection assembly, wherein the housing comprises a window portion located on an emergent light path of the illumination assembly and on an incident light path of the detection assembly, so that the illumination beam and the imaging beam can transmit through the window portion.

2. The optical imaging sensor according to claim 1, wherein the illumination assembly comprises:
an illumination source, configured to generate an initial beam.

3. The optical imaging sensor according to claim 2, wherein the illumination assembly further comprises:
a beam shaping assembly, disposed on an emergent light path of the illumination source, and configured to perform beam shaping to generate the illumination beam with a preset shape.

4. The optical imaging sensor according to claim 3, wherein the beam shaping assembly comprises:
a diaphragm, disposed on the emergent light path of the illumination source, and comprising a shading screen and a light-transmissive portion arranged in the shading screen, wherein the light-transmissive portion is rectangular; and
a cylindrical lens group, disposed on an emergent light path of the diaphragm;
wherein the cylindrical lens group and the diaphragm are configured to shape the beam to generate a substantially sheet-like illumination beam, and a plane in which the illumination beam is located is substantially perpendicular to the second direction.

5. The optical imaging sensor according to claim 4, wherein the cylindrical lens group comprises a first cylindrical lens, wherein a convex surface of the first cylindrical lens is disposed facing the diaphragm.

6. The optical imaging sensor according to claim 4, wherein in a case that the illumination source is an incoherent light source, a minimum thickness Z of the illumination beam in the second direction satisfies Z=1.4*f*λ/(2*D), an effective length L of the illumination beam in the first direction satisfies L=2*n*π*Z2/λ, and an effective width of the illumination beam in a third direction satisfies W=D′*NA, wherein the third direction is perpendicular to both the first direction and the second direction, f is a focal length of the cylindrical lens group, λ is a wavelength of the illumination beam, D is a side length of the light-transmissive portion in the second direction, D′ is a side length of the light-transmissive portion in the third direction, n is a refractive index of a medium in which the illumination beam is transmitted, and NA is a numerical aperture of the illumination assembly.

7. The optical imaging sensor according to claim 4, wherein in a case that the illumination source is a coherent light source, a minimum thickness Z of the illumination beam in the second direction satisfies Z=2*λ/(π*NA), an effective length L of the illumination beam in the first direction satisfies L=2*n*λ/(π*NA2), and an effective width of the illumination beam in a third direction satisfies W=D′*NA, wherein the third direction is perpendicular to both the first direction and the second direction, λ is a wavelength of the illumination beam, NA is a numerical aperture of the illumination assembly, n is a refractive index of a medium in which the illumination beam is transmitted, and D′ is a side length of the light-transmissive portion in the third direction.

8. The optical imaging sensor according to claim 4, wherein the diaphragm comprises an adjustable diaphragm, and a light-transmissive range of the light-transmissive portion of the adjustable diaphragm is changeable.

9. The optical imaging sensor according to claim 4, wherein the illumination assembly further comprises:
a collimating lens group, disposed on an emergent light path of the beam shaping assembly, and configured to perform beam collimation to generate the collimated illumination beam.

10. The optical imaging sensor according to claim 1, wherein the detection assembly comprises:
an imaging lens group, configured to receive the imaging beam; and
an optical detector, disposed on an emergent light path of the imaging lens group and configured to sense the imaging beam.

11. The optical imaging sensor according to claim 10, wherein the imaging lens group comprises:
an objective lens; and
a tube lens, disposed between the objective lens and the optical detector.

12. The optical imaging sensor according to claim 10, wherein the detection assembly further comprises:
an optical filter, disposed on an incident light path of the optical detector, and configured to filter out a part of the imaging beam in a preset waveband, and enable a part of the imaging beam in another waveband to pass through.

13. The optical imaging sensor according to claim 1, wherein the illumination assembly is positioned such that the illumination beam covers at least a focal plane of the detection assembly.

14. The optical imaging sensor according to claim 1, wherein the window portion is formed of a light-transmissive hard material or a light-transmissive flexible material.

15. The optical imaging sensor according to claim 1, wherein another portion of the housing than the window portion is formed of a non-light-transmissive material.

16. A biological reaction system, comprising:
a reaction vessel, at least a part of which is formed of a light-transmissive material; and
the optical imaging sensor according to claim 1, wherein the window portion of the optical imaging sensor is configured to abut against the part of the reaction vessel formed of the light-transmissive material, to monitor a biological reaction in the reaction vessel.

17. The biological reaction system according to claim 16, further comprising:
a memory, having instructions stored therein; and
a processor, communicatively connected with the optical imaging sensor and the memory, and when the instructions are executed by the processor, implementing image processing of an imaged image generated by the optical imaging sensor.
